(19) United States
(12) Patent Application Publication
(10) Pub. No.: US 2007/0267206 A1
(43) Pub. Date: Nov. 22, 2007

(54) Single-hand operable structure for controlling forward/backward intake of a straight pneumatic wrench

(75) Inventor: Hsin-Chi Chen, Taiping City (TW)

Correspondence Address: TROXELL LAW OFFICE PLLC;SUITE 1404, 5205 LEESBURG PIKE, FALLS CHURCH, VA, 22041, US

(73) Assignee: Tranmax Machinery Co., Ltd.

(21) Appl. No.: 11/486,315

(22) Filed: Jul. 14, 2006

(30) Foreign Application Priority Data
May 19, 2006 (TW) 095208708

(51) Int. Cl. B23B 45/00

(52) U.S. Cl. 173/170

(57) ABSTRACT

A single-hand operable structure for controlling forward/backward intake of a straight pneumatic wrench, including: a main body having a housing defining an internal air chamber, the housing having an intake passage through which external gas can go into the air chamber, two arms respectively rearward extending from a rear end of the housing by a predetermined length, a handle being bridged between rear ends of the two arms, the rear end of the housing being formed with at least one through hole with a predetermined shape between the two arms; and a controlling valve having a valve section disposed inside the housing in an intake path of the intake passage for controlling/changing an intake position or flow amount of the gas flowing from the intake passage into the air chamber, the controlling valve further including an operating/controlling section connected with the valve section and partially extending through the through hole of the rear end of the housing for an operator to operate the valve section.

### BACKGROUND OF THE INVENTION

The present invention is related to a pneumatic tool, and more particularly to a single-hand operable structure for controlling forward/backward intake of a straight pneumatic wrench.

FIG. 1 shows a conventional straight pneumatic wrench 1 having a body section 2 in which a pneumatic cylinder and a fan are accommodated. Via a striking mechanism, the power is output from an output shaft 3. One end of the body section 2 is equipped with a first substantially annular handle 4. In addition, a second handle 5 arranged on one side of the body section 2. An operator can hold the handles 4, 5 with both hands to operate the straight pneumatic wrench 1.

It is found by the applicant that in the conventional technique, the forward/backward controlling mechanism for controlling the intake direction and airflow amount lacks a suitable operating/controlling structure. Therefore, when switching the operation direction between forward and backward directions or changing the airflow amount, an operator needs to hold the handle 4 with one hand and the operator's other hand must release the other handle 5 to shift the controlling valve 6 for switching the operation direction or changing the airflow amount for changing the rotational speed.

On one hand, the above operation is quite inconvenient to the operator. On the other hand, the straight pneumatic wrench are so heavy that when the operator switching the shifting the controlling valve 6, it is hard for the operator to steadily hold the straight pneumatic wrench with single hand. As a result, the straight pneumatic wrench may drop down. This may lead to an accident.

### SUMMARY OF THE INVENTION

It is therefore a primary object of the present invention to provide a single-hand operable structure for controlling forward/backward intake of a straight pneumatic wrench. According to the single-hand operable structure, the operating/controlling end of the straight pneumatic wrench is considerably adjacent to the handle so that an operator can shift the operating/controlling end with both hands keeping holding the straight pneumatic wrench.

According to the above object, the single-hand operable structure for controlling forward/backward intake of the straight pneumatic wrench of the present invention includes: a main body having a housing defining an internal air chamber, the housing having an intake passage through which external gas can go into the air chamber, two arms respectively rearward extending from a rear end of the housing by a predetermined length, a handle being bridged between rear ends of the two arms, the rear end of the housing being formed with at least one through hole with a predetermined shape between the two arms; and a controlling valve having a valve section disposed inside the housing in an intake path of the intake passage for controlling/changing an intake position or flow amount of the gas flowing from the intake passage into the air chamber, the controlling valve further including an operating/controlling section connected with the valve section and partially extending through the through hole of the rear end of the housing for an operator to operate the valve section.

The present invention can be best understood through the following description and accompanying drawings wherein:

### BRIEF DESCRIPTION OF THE DRAWINGS

FIG. 1 is a perspective assembled view of a conventional straight pneumatic wrench;

FIG. 2 is a perspective assembled view of a first embodiment of the present invention;

FIG. 3 is a perspective exploded view of the first embodiment of the present invention;

FIG. 4 is a sectional view taken along line 4-4 of FIG. 2;

FIG. 5 is a rear end view of the first embodiment of the present invention;

FIG. 6 is a side view of the first embodiment of the present invention;

FIG. 7 is a perspective exploded view of the operating/controlling section and the valve block of the first embodiment of the present invention;

FIG. 8 is a perspective assembled view of a second embodiment of the present invention;

FIG. 9 is a perspective exploded view of the second embodiment of the present invention;

FIG. 10 is a sectional view taken along line 10-10 of FIG. 8;

FIG. 11 is a rear end view of the second embodiment of the present invention;

FIG. 12 is a side view of the second embodiment of the present invention; and

FIG. 13 is a perspective exploded view of the operating/controlling section and the valve block of the second embodiment of the present invention.

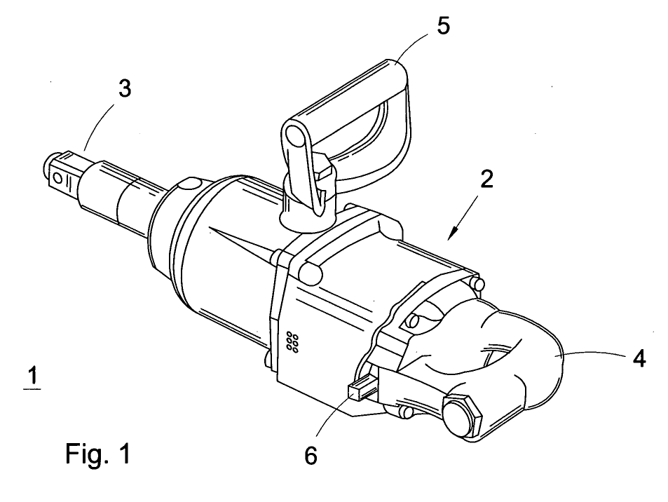

### DETAILED DESCRIPTION OF THE PREFERRED EMBODIMENTS

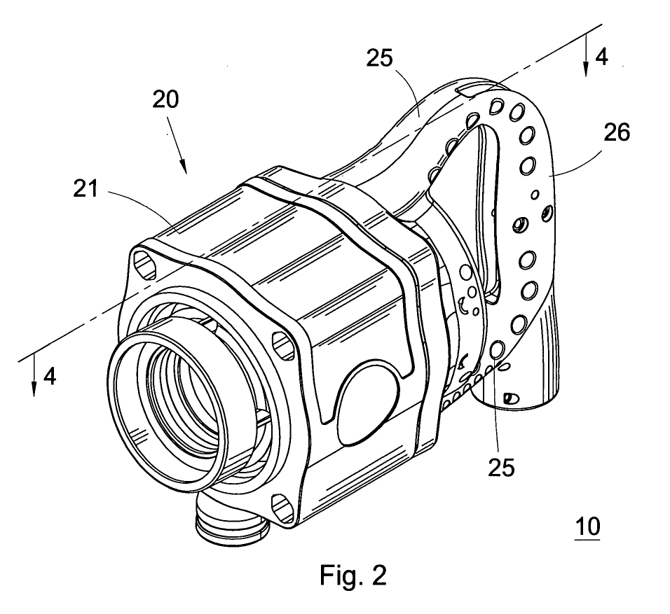

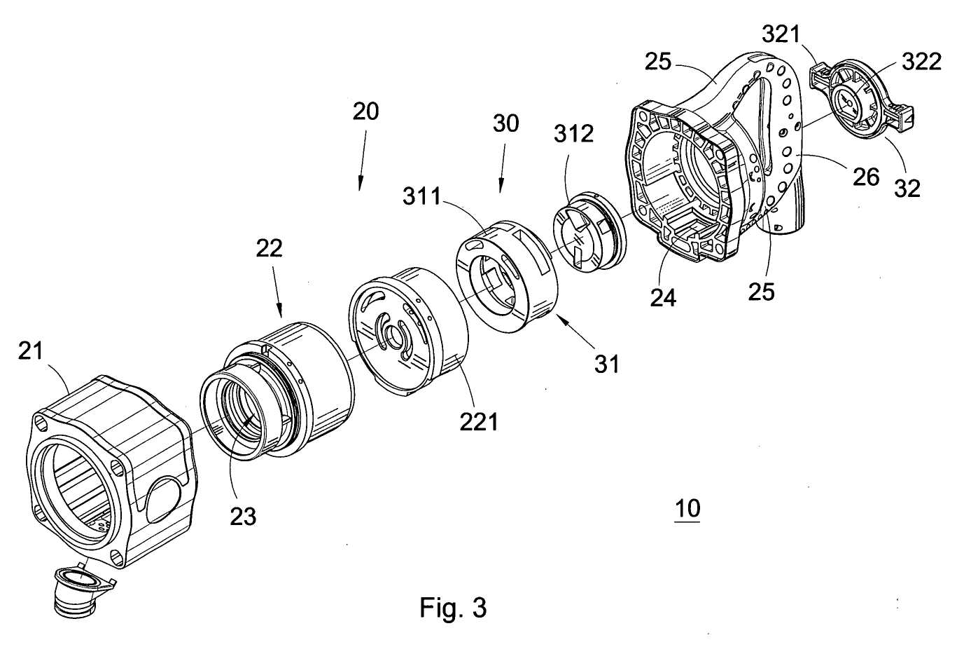

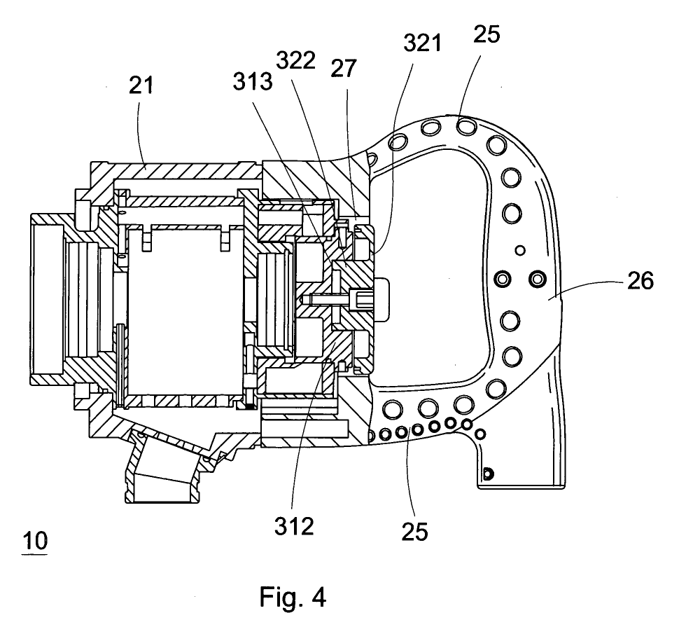

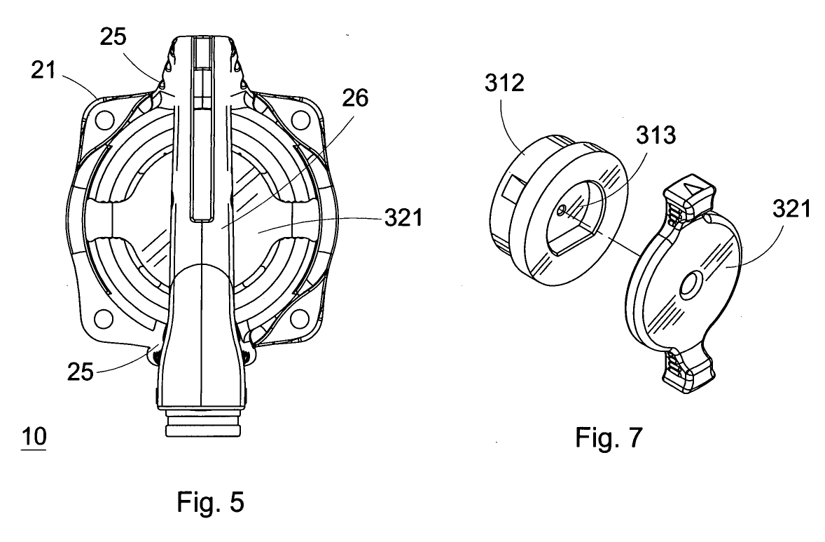

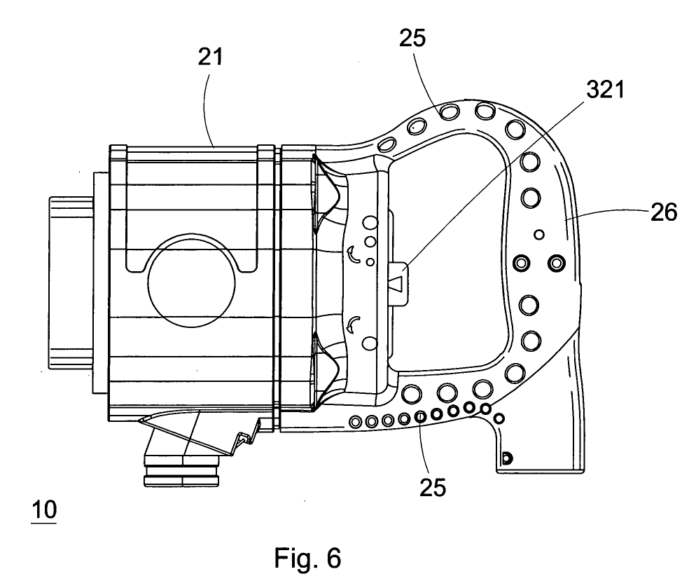

Please refer to FIGS. 2 to 7. The single-hand operable structure 10 for controlling forward/backward intake of a straight pneumatic wrench of the present invention includes a main body 20 and a controlling valve 30.

The main body 20 has a configuration similar to that of prior art. The main body 20 has a substantially column-shaped housing 21. A tubular pneumatic cylinder 22 is coaxially fixedly disposed in the housing 21. The pneumatic cylinder 22 defines an internal cylindrical air chamber 23 in which a rotor is arranged. The wall of the pneumatic cylinder 22 is formed with airflow ways as in the conventional pneumatic cylinder. The housing 21 has an intake passage 24 through which the external high-pressure gas can go through the flow way of the pneumatic cylinder 22 into the air chamber 23. Two arms 25 respectively rearward extend from a rear end of the housing 21 by a certain length. An elongated handle 26 is bridged between the ends of the two arms 25. The wall of the rear end of the housing 21 is coaxially formed with a circular through hole 27 between the two arms 27.

The controlling valve 30 has a valve section 31 disposed in the intake path of the intake passage 24 for controlling/changing the intake position or flow amount of the gas flowing from the intake passage 24 into the air chamber 23. This technique has been disclosed in this applicant's Taiwanese Utility Model Patent Nos. 91215523 and 92208148 and thus will not be further described hereinafter. The controlling valve 30 further includes an operating/controlling section 32 connected with the valve section 31 and positioned behind the rear end of the housing 21 for an operator to operate.

To speak more detailedly, the valve section 31 has a ring-shaped valve sleeve 311 coaxially accommodated in an annular wall 221 extending from one end of the pneumatic cylinder 22. The valve section 31 further has a circular valve block 312 coaxially fitted in the valve sleeve 311. The valve block 312 is rotatable about a curvature center. A noncircular engaging hole 313 is formed on an end face of the valve block 312.

The operating/controlling section 32 includes a flat plate-shaped rotary block 321 with a certain profile. One face of the rotary block 321 attaches to the rear end face of the housing 21. A noncircular engaging boss 322 perpendicularly projects from the face of the rotary block 321 and coaxially passes through the through hole 27 to engage in the engaging hole 313.

According to the above arrangement, when operating the straight pneumatic wrench, an operator can hold the handle 26 with one hand. In addition, the fingers of the hand can directly reach the operating/controlling section 32. Therefore, with the hand keeping holding the handle 26, the fingers of the hand can touch the operating/controlling section 32 to shift the valve section 31 so as to switch the operation direction or rotational speed of the straight pneumatic wrench. This facilitates the operation of the straight pneumatic wrench.

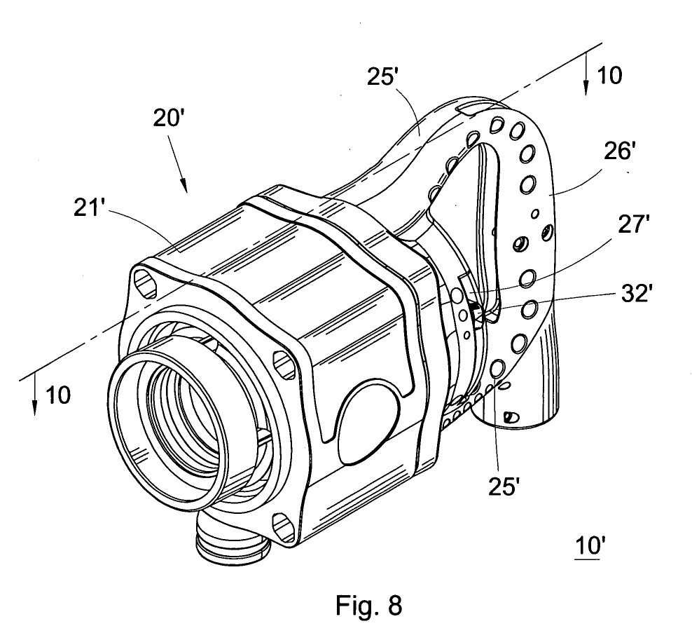

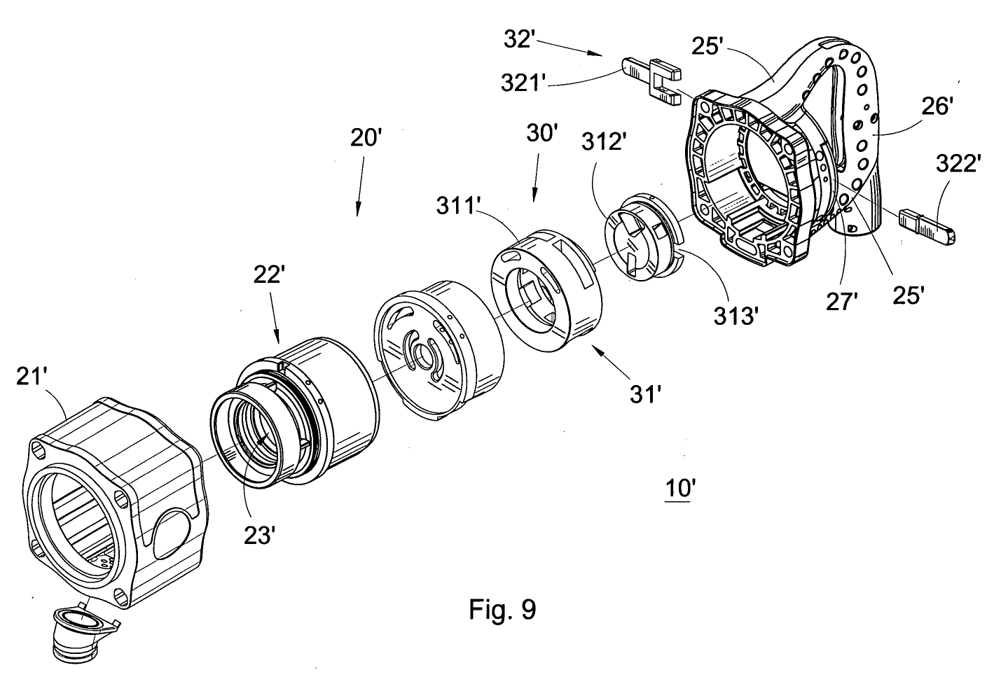

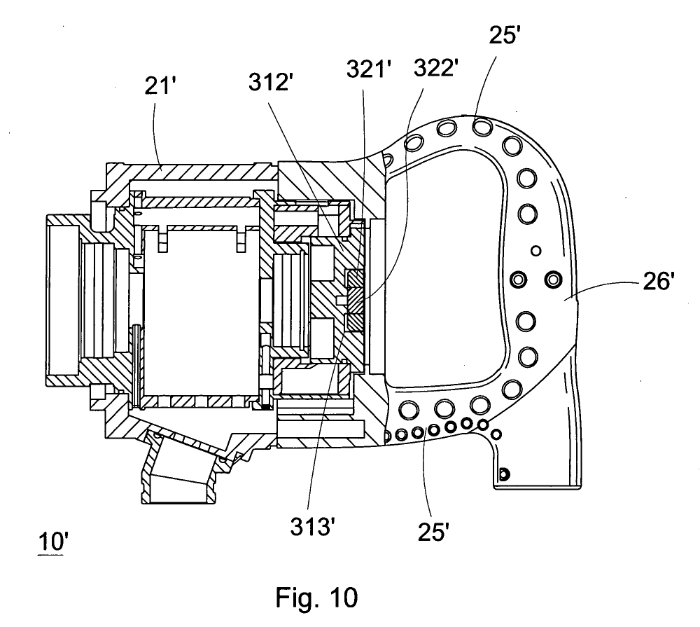

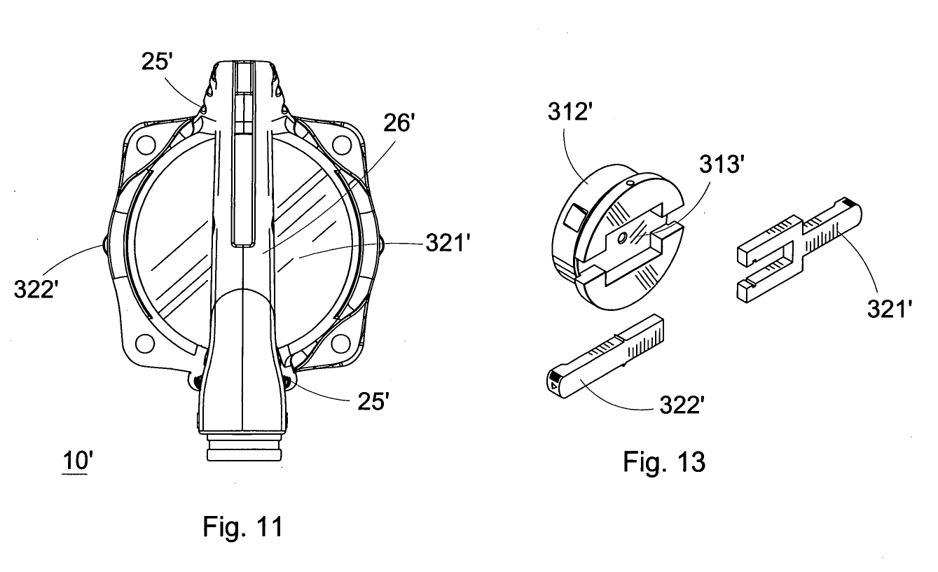

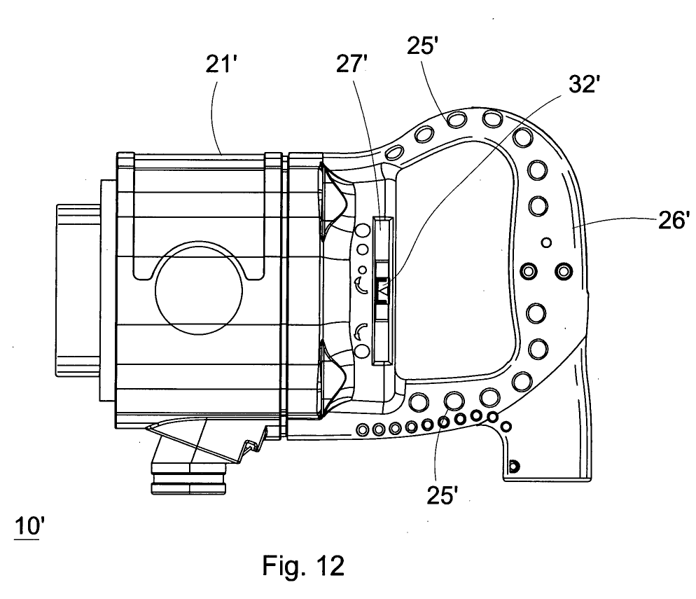

FIGS. 8 to 13 show a second embodiment of the single-hand operable structure 10′ for controlling forward/backward intake of the straight pneumatic wrench of the present invention, which is substantially identical to the first embodiment. The only difference between the two embodiments is that the arrangements of operating/controlling ends are different from each other.

In the second embodiment, the main body 20′ is formed with two arced slots 27′ symmetrically arranged on the circumference wall of the rear end of the housing 21′. The operating/controlling section 32′ is bar-like and composed of a first shaft bar 321′ and a second shift bar 322′ serially connected with each other. A middle section of the operating/controlling section 32′ is engaged in a bar-shaped engaging slot 313′ of the valve section 31′. Two ends of the operating/controlling section 32′ respectively extend through the two arced slots 27′ out from the circumference of the rear end of the housing 21′. Accordingly, the first shaft bar 321′ and the second shift bar 322′ form two symmetrical operating/controlling ends extending out from the circumference of the rear end of the housing 21′. This can achieve the same effect as the first embodiment.

In conclusion, the present invention is characterized in that the operating/controlling end is considerably adjacent to the handle so that an operator can shift the operating/controlling end with both hands keeping holding the straight pneumatic wrench.

The above embodiments are only used to illustrate the present invention, not intended to limit the scope thereof. Many modifications of the above embodiments can be made without departing from the spirit of the present invention.

What is claimed is:

1. A single-hand operable structure for controlling forward/backward intake of a straight pneumatic wrench, comprising:
a main body having a housing defining an internal air chamber, the housing having an intake passage through which external gas can go into the air chamber, two arms respectively rearward extending from a rear end of the housing by a predetermined length, a handle being bridged between rear ends of the two arms, the rear end of the housing being formed with at least one through hole with a predetermined shape between the two arms; and
a controlling valve having a valve section disposed inside the housing in an intake path of the intake passage for controlling/changing an intake position or flow amount of the gas flowing from the intake passage into the air chamber, the controlling valve further including an operating/controlling section connected with the valve section and partially extending through the through hole of the rear end of the housing for an operator to operate the valve section.

2. The single-hand operable structure for controlling forward/backward intake of the straight pneumatic wrench as claimed in claim 1, wherein the operating/controlling section is bar-like, a middle section of the operating/controlling section is engaged with a predetermined section of the valve section, at least one end of the operating/controlling section extending through the through hole out from the housing.

3. The single-hand operable structure for controlling forward/backward intake of the straight pneumatic wrench as claimed in claim 2, wherein the operating/controlling section is composed of a first shaft bar and a second shift bar serially connected with each other.

4. The single-hand operable structure for controlling forward/backward intake of the straight pneumatic wrench as claimed in claim 1, wherein the operating/controlling section includes a rotary block one face of which attaches to the rear end face of the housing, a noncircular engaging boss perpendicularly projecting from the face of the rotary block and coaxially passing through the through hole to engage with a predetermined section of the valve section.

5. The single-hand operable structure for controlling forward/backward intake of the straight pneumatic wrench as claimed in claim 1, wherein the valve section includes a ring-shaped valve sleeve and a circular valve block coaxially fitted in the valve sleeve, the valve block being rotatable about a curvature center.

6. The single-hand operable structure for controlling forward/backward intake of the straight pneumatic wrench as claimed in claim 5, wherein a predetermined section of the operating/controlling section is engaged with one end face of the valve block.
